(19) United States
(12) Patent Application Publication
(10) Pub. No.: US 2007/0014348 A1
(43) Pub. Date: Jan. 18, 2007

(54) Method and system for motion compensated fine granularity scalable video coding with drift control

(75) Inventors: Yiliang Bao, Coppell, TX (US); Marta Karczewicz, Irving, TX (US); Justin Ridge, Sachse, TX (US); Xianglin Wang, Irving, TX (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/403,233

(22) Filed: Apr. 12, 2006

Related U.S. Application Data
(60) Provisional application No. 60/670,794, filed on Apr. 12, 2005.
(60) Provisional application No. 60/671,263, filed on Apr. 13, 2005.
(60) Provisional application No. 60/724,521, filed on Oct. 6, 2005.

(51) Int. Cl. H04B 1/66; H04N 11/04

(52) U.S. Cl. 375/240.1; 375/240.24; 375/240.27

(57) ABSTRACT

An adaptively formed reference block is used for coding a block in a current frame in the enhancement layer. In particular, the reference block is formed from a reference block in base layer reconstructed frame and a reference block in the enhancement layer reference frame together with a base layer reconstructed prediction residual block. Furthermore, the reference block for coding is adjusted depending on the transform coefficients of the base layer reconstructed residual layer. Moreover, the actual reference signal used for coding is a weighted average of a reference signal from the reconstructed frame in the base layer and a reference signal from the enhancement layer reference frame together with a base layer reconstruction prediction residual.

The present invention is based on and claims priority to U.S. Provisional Patent Application No. 60/670,797, filed Apr. 12, 2005; U.S. Provisional Patent Application No. 60/671,263, filed Apr. 13, 2005; and U.S. Provisional Patent Application No. 60/724,521, filed Oct. 6, 2005.

### FIELD OF THE INVENTION

This invention relates to the field of video coding, and more specifically to scalable video coding.

### BACKGROUND OF THE INVENTION

In video coding, temporal redundancy existing among video frames can be minimized by predicting a video frame based on other video frames. These other frames are called the reference frames. Temporal prediction can be carried out in different ways:

The decoder uses the same reference frames as those used by the encoder. This is the most common method in conventional non-scalable video coding. In normal operations, there should not be any mismatch between the reference frames used by the encoder and those by the decoder.

The encoder uses the reference frames that are not available to the decoder. One example is that the encoder uses the original frames instead of reconstructed frames as reference frames.

The decoder uses the reference frames that are only partially reconstructed compared to the frames used in the encoder. A frame is partially reconstructed if either the bitstream of the same frame is not fully decoded or its own reference frames are partially reconstructed.

When temporal prediction is carried out according to the second and the third methods, mismatch is likely to exist between the reference frames used by the encoder and those by the decoder. If the mismatch accumulates at the decoder side, the quality of reconstructed video suffers.

Mismatch in the temporal prediction between the encoder and the decoder is called a drift. Many video coding systems are designed to be drift-free because the accumulated errors could result in artifacts in the reconstructed video. Sometimes, in order to achieve certain video coding features, such as SNR scalability, more efficiently, drift is not always completely avoided.

A signal-to-noise ratio (SNR) scalable video stream has the property that the video of a lower quality level can be reconstructed from a partial bitstream. Fine granularity scalability (FGS) is one type of SNR scalability in which the scalable stream can be arbitrarily truncated. FIG. 1 illustrates how a stream of FGS property is generated in MPEG-4. Firstly a base layer is coded in a non-scalable bitstream. FGS layer is then coded on top of that. MPEG-4 FGS does not exploit any temporal correlation within the FGS layer. As shown in FIG. 2, when no temporal prediction is used in FGS layer coding, the FGS layer is predicted from the base layer reconstructed frame. This approach has the maximal bitstream flexibility since truncation of the FGS stream of one frame will not affect the decoding of other frames, but the coding performance is not competitive.

It is desirable to introduce another prediction loop in the FGS layer coding to improve the coding efficiency. However, since the FGS layer of any frame can be partially decoded, the error caused by the difference between the reference frames used in the decoder and encoder will accumulate and the drift is resulted. This is illustrated in FIG. 3.

Leaky prediction is a technique that has been used to seek a balance between coding performance and drift control in SNR enhancement layer coding (see, for example, Huang et al. “A robust fine granularity scalability using trellis-based predictive leak”, IEEE Transaction on Circuits and Systems for Video Technology”, pp. 372-385, vol. 12, Issue 6, June 2002). To encode the FGS layer of the n^{th} frame, the actual reference frame is formed with a linear combination of the base layer reconstructed frame (x_{b}ⁿ) and the enhancement layer reference frame (rₑⁿ⁻¹). If an enhancement layer reference frame is partially reconstructed in the decoder, the leaky prediction method will limit the propagation of the error caused by the mismatch between the reference frame used by the encoder (rₑ^{n-1,E}) and that used by the decoder (rₑ^{n-1,D}), since the error (Eₑⁿ⁻¹) will be attenuated every time a new reference signal is formed.
rₐ^{n,D}=α·x_{b}ⁿ+(1−α)·rₑ^{n-1,D}=α·x_{b}ⁿ=(1−α)·rₑ^{n-1,E}−(1−α)·Eₑⁿ⁻¹=rₐ^{n,E}−(1−α)·Eₑⁿ⁻¹ (1)
where rₐ^{n,D}, rₐ^{n,E} are the actual reference frames used in FGS layer coding in the decoder and the encoder, respectively, and α is a value given by 0<α≦1 in order to achieve attenuation of error signal.

The third technique is to classify the DCT coefficients in a block to be encoded in the enhancement layer according to the value of the corresponding quantized coefficients in the base layer (see Comer “Conditional replacement for improved coding efficiency in fine-grain scalable video coding”, International Conference on Image Processing, vol. 2, pp. 57-60, 2002). The decision as to whether the base or enhancement layer is used for prediction is made per each coefficient. If a quantized coefficient in the base layer is zero, the corresponding DCT coefficient in the enhancement layer will be predicted using the DCT coefficient calculated from the enhancement layer reference frame. If this quantized coefficient in the base layer is nonzero, the corresponding DCT coefficient in the enhancement layer will be predicted using the DCT coefficient calculated from the reference block from the base layer reconstructed frame.

An FGS coder has been developed and included in Joint Scalable Video Model 1.0 (JSVM 1.0), which is the official model used by MPEG/VCEG for the standardization activities on the scalable extension of AVC. However, JSVM1.0 FGS coder is not designed to manage the drift. The FGS layer of an anchor frame, which is at the boundary of a GOP (group of picture), is coded in a way similar to MPEG-4 FGS where the temporal redundancy is not exploited. For some applications, the length of GOP could be as short as 1 frame. In this case, the JSVM1.0 FGS coder is very inefficient because every frame is coded as an anchor frame.

FIG. 4 gives the prediction paths in a 3-layer scalable video stream. An FGS layer is inserted in between 2 discrete layers. The upper discrete enhancement layer can be a spatial enhancement layer or a coarse SNR scalability layer. This upper enhancement layer is usually coded based on the FGS layer using either the base layer texture prediction mode or the residual prediction mode. In the base layer texture prediction mode, a block in the reconstructed FGS layer is used as the reference for coding a block in the upper discrete enhancement layer. In the residual prediction mode, the residual reconstructed from both the base layer and FGS layer is used as the prediction for coding the prediction residual in the enhancement layer. The decoding of upper enhancement layer can still be performed even if the FGS layer in the middle is only partially reconstructed. However, the upper enhancement layer has a drift problem because of the partial decoding of the FGS layer.

### SUMMARY OF THE INVENTION

The present invention provides a fine granularity SNR scalable video codec that exploits the temporal redundancy in the FGS layer in order to improve the coding performance while the drift is controlled. More specifically the present invention focuses on how the reference blocks used in predictive coding in FGS layer should be formed, and the signaling and mechanism that are needed to control the process.

The present invention improves the efficiency of FGS coding, especially under low-delay constraints. The present invention is effective in controlling the drift, and thus a fine granularity scalability (FGS) coder of better performance can be designed accordingly.

According to the present invention, when coding a block in a current frame in the enhancement layer, an adaptively formed reference block is used. In particular, the reference block is formed from a reference block in base layer reconstructed frame and a reference block in the enhancement layer reference frame together with a base layer reconstructed prediction residual block. Furthermore, the reference block for coding is adjusted depending on the coefficients coded in the base layer. Moreover, the actual reference signal used for coding is a weighted average of a reference signal from the reconstructed frame in the base layer and a reference signal from the enhancement layer reference frame together with a base layer reconstruction prediction residual.

Accordingly, the first aspect of the present invention provides a method for motion compensated scalable video coding, wherein the method comprises forming the reference block and adjusting the reference block. The method further comprises choosing a weighting factor so that the reference block is formed as weighted average of the base layer reference block and the enhancement layer reference block.

The second aspect of the present invention provides a software application product having a storage medium to store program codes to carry out the method of the present invention.

The third aspect of the present invention provides an electronic module for use in motion compensated video coding. The electronic module comprises a formation block for forming the reference block and an adjustment block for adjust the reference block according to the method of the present invention.

The fourth aspect of the present invention provides an electronic device, such as a mobile terminal, having one or both of a decoding module and an encoding module having a module for motion compensated video coding. The electronic module comprises a formation block for forming the reference block and an adjustment block for adjust the reference block according to the method of the present invention.

The present invention will become apparent upon reading the description taken in conjunction with FIGS. 5-11.

### BRIEF DESCRIPTION OF THE DRAWINGS

FIG. 1 illustrates fine granularity scalability with no temporal prediction in the FGS layer (MPEG-4).

FIG. 2 illustrates reference blocks being used in coding the base layer and FGS layer, when no temporal prediction is used in the FGS layer coding.

FIG. 3 illustrates fine granularity scalability with temporal prediction.

FIG. 4 show the use of FGS information in predicting the upper enhancement layer.

FIG. 5 illustrates generation of reference block with FGS layer temporal prediction and drift control, according to the present invention.

FIG. 6 illustrates base-layer dependent adaptive reference block formation, according to the present invention.

FIG. 7 illustrates reference block formation by performing interpolation on differential reference frame, according to the present invention.

FIG. 8 illustrates base-layer dependent differential reference block adjustment, according to the present invention.

FIG. 9 illustrates an FGS encoder with base-layer-dependent formation of reference block, according to the present invention.

FIG. 10 illustrates an FGS decoder with base-layer-dependent formation of reference block, according to the present invention.

FIG. 11 illustrates an electronic device having at least one of the scalable encoder and the scalable decoder, according to the present invention.

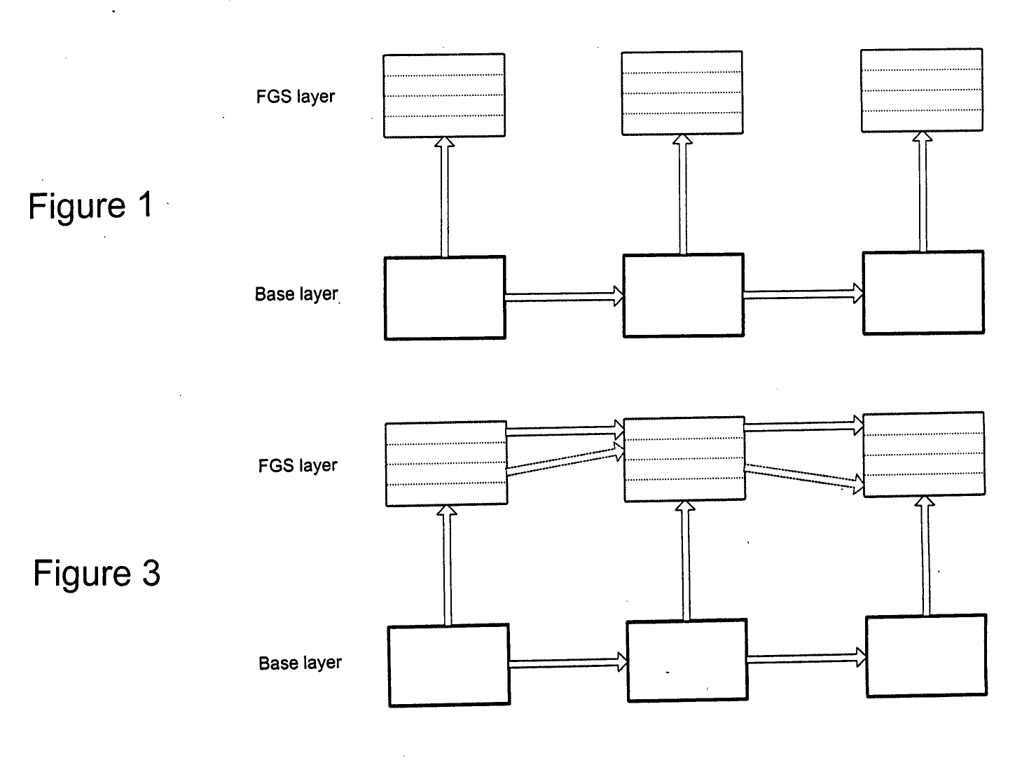

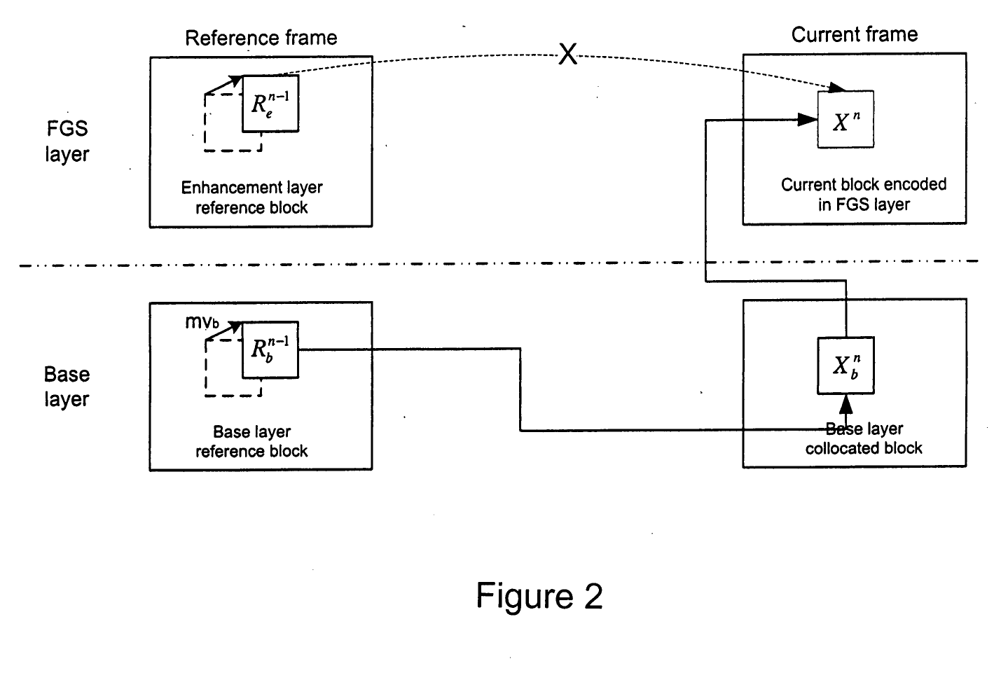

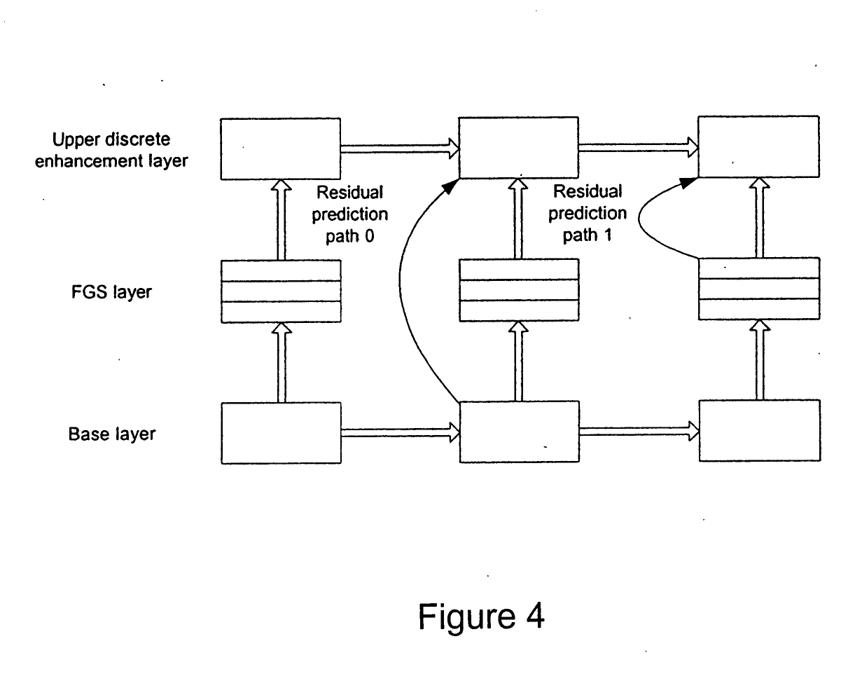

### DETAILED DESCRIPTION OF THE INVENTION

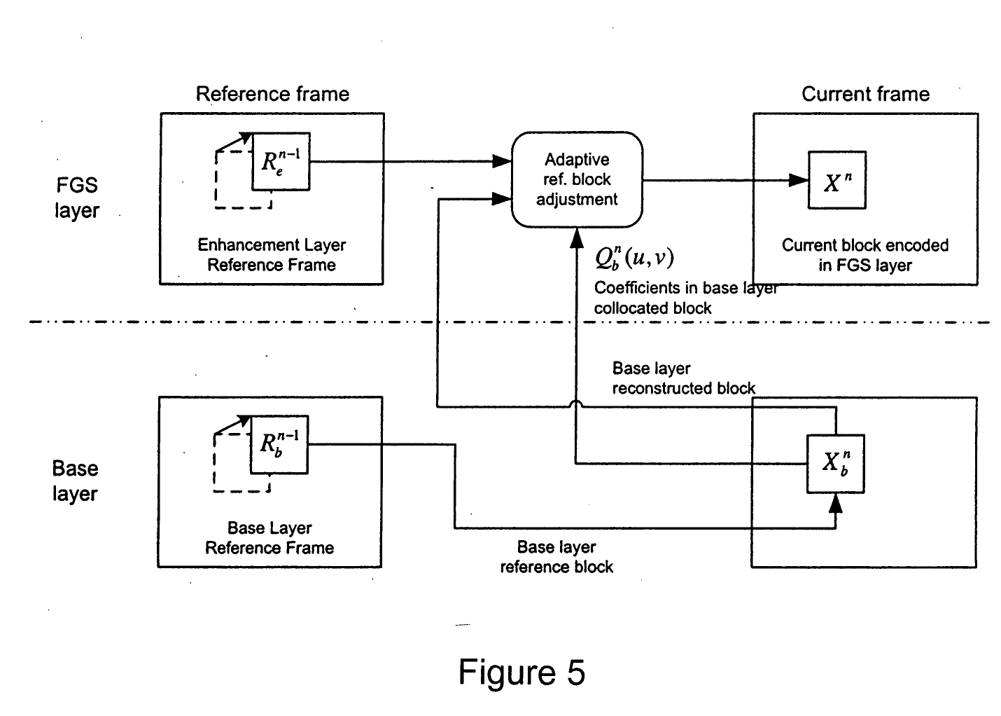

As in typical predictive coding in a non-scalable single layer video codec, to code a block Xⁿ of size M×N pixels in the FGS layer, a reference block Rₐⁿ is used. Rₐⁿ is formed adaptively from a reference block X_{b}ⁿ from the base layer reconstructed frame and a reference block Rₑⁿ⁻¹ from the enhancement layer reference frame based on the coefficients coded in the base layer, Q_{b}ⁿ. FIG. 5 gives the relationship among these blocks. Here a block is a rectangular area in the frame. The size of a block in the spatial domain is the same as the size of the corresponding block in the coefficient domain.

In the FGS coder, according to the present invention, the same original frame is coded in the enhancement layer and the base layer, but at different quality levels. The base layer collocated block refers to the block coded in the base layer that corresponds to the same original block that is being processed in the enhancement layer.

In the following, Q_{b}ⁿ is a block of quantized coefficients coded in the base layer corresponding to the same original block being coded in the enhancement layer. In the present invention, only the information whether individual coefficients, Q_{b}ⁿ(u, v), are zero or not is important.

If Q_{b}ⁿ=0, i.e., all coefficients Q_{b}ⁿ(u, v) with (0≦u<M, 0≦v<N) are zero, then the reference block Rₐⁿ is calculated as the weighted average of X_{b}ⁿ and Rₑⁿ⁻¹ as follows:
Rₐⁿ=α·X_{b}ⁿ+(1−α)·Rₑⁿ⁻¹ if Q_{b}ⁿ=0 (2)
where α is a weighting factor.

Otherwise, transform is performed on X_{b}ⁿ and Rₑⁿ⁻¹ to obtain the transform coefficients Fₓ_{_{b}}_{ⁿ}=f(X_{b}ⁿ), F_{R}_{ₑ}_{^{n−1}}=f(Rₑⁿ⁻¹) respectively. A coefficient block F_{R}_{ₐ}_{ⁿ}(u,v) with (0≦u<M, 0≦v<N) is formed based on the base layer coefficient value:
F_{R}_{ₐ}_{ⁿ}(u,v)=β·F_{X}_{_{b}}_{ⁿ}(u,v)+(1−β)·F_{R}_{ₑ}_{^{n−1}}(u,v) if Q_{b}ⁿ(u,v)=0 (3)
F_{R}_{ₐ}_{ⁿ}(u,v)=F_{X}_{_{b}}_{ⁿ}(u,v) if Q_{b}ⁿ(u, v)≠0 (4)
where β is a weighting factor.

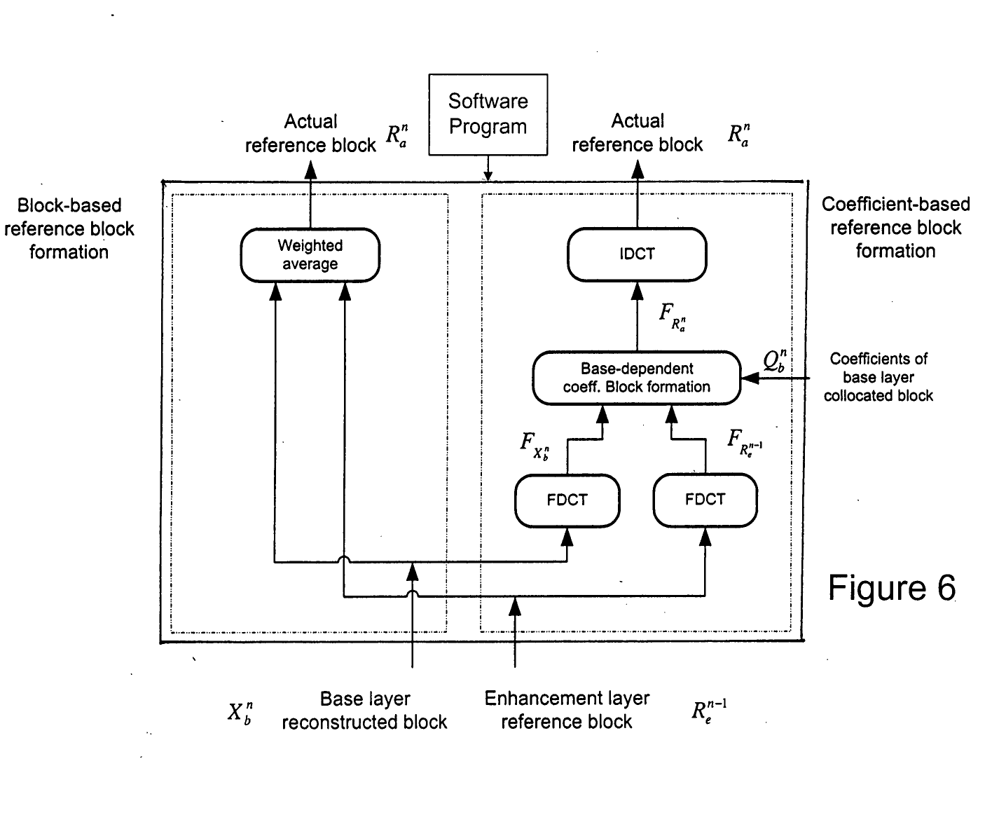

The actual reference block is then obtained by performing inverse transform on F_{R}_{ₐ}_{ⁿ} as follows:
Rₐⁿ=g(F_{R}_{ₐ}_{ⁿ}).
All weighting factors are always in the range [0, 1]. The base-layer dependent adaptive reference block formation is illustrated in FIG. 6.

In one embodiment of the present invention, weighting factor α is set to 0, and weighting factor β is set to 1. In this case, the base layer reconstructed block will be selected as the actual reference block if the block being coded in the FGS layer has some nonzero coefficients in the base layer, or the enhancement layer reference block will be selected as the actual reference block if the block being coded does not have any non-zero coefficients in the base layer. This is a simple design. Decision on whether the data of a reference block should be from the base layer reconstructed frame or the enhancement layer reference frame is only made at the block level and no additional transform or weighted averaging operations are needed.

In another embodiment of the present invention, the value of weighting factor α is not restricted, and the value of weighting factor β depends on the frequency of the coefficient being considered.

In yet another embodiment, weighting factor α is not restricted, the value of weighting factor β depends on the FGS coding cycle in which the current coefficient is coded.

In the following, the lower case variables, such as x_{b}ⁿ and rₐⁿ, are used for general discussion. The upper case variables, such as X_{b}ⁿ and Rₐⁿ, are used for representing the signals in the spatial domain, while their corresponding transform coefficients are denoted as F_{X}_{_{b}}_{ⁿ} and F_{R}_{ₐ}_{ⁿ}, etc.

The present invention provides a number of algorithms for generating the optimal reference signals to be used in FGS layer coding. With these algorithms, the temporal prediction is efficiently incorporated in FGS layer coding to improve the coding performance while the drift is effectively controlled.

As discussed above, to introduce the temporal prediction in the FGS layer and control the drift, the actual reference signal is a weighted average of the reference signal from the reconstructed frame in the base layer and that from the enhancement layer reference frame:
rₐⁿ=α·x_{b}ⁿ+(1−α)·rₑⁿ⁻¹ (5)
The base layer reconstructed signal x_{b}ⁿ itself is calculated from the base layer reference signal r_{b}ⁿ⁻¹, and the base layer reconstructed prediction residual p_{b}ⁿ:
x_{b}ⁿ=r_{b}ⁿ⁻¹+p_{b}ⁿ (6)
The actual reference signal can be constructed as follows:
rₐⁿ=α·r_{b}ⁿ⁻¹+α·p_{b}ⁿ+(1−α)·rₑⁿ⁻¹ (7)

According to the present invention, this relationship is generalized by introducing an independent scaling factor αₚ for the base layer reconstructed prediction residual, p_{b}ⁿ:
rₐⁿ=α·r_{b}ⁿ⁻¹+αₚ·p_{b}ⁿ+(1−α)·rₑⁿ⁻¹ (8)
The independent scaling factor αₚ has a value between 0 and 1. When the scaling factor is equal to 1, the base layer reconstructed prediction residual is not scaled.

Accordingly, the algorithm for generating the actual reference block can be generalized as follows:
If all coefficients Q_{b}ⁿ(u,v) are zero, X_{b}ⁿ=R_{b}ⁿ⁻¹. The actual reference block Rₐⁿ is calculated as the weighted average of R_{b}ⁿ⁻¹ and Rₑⁿ⁻¹:
   Rₐⁿ=α·R_{b}ⁿ⁻¹+(1−α)·Rₑⁿ⁻¹ if Q_{b}ⁿ=0 (9)
Otherwise, transform is performed on R_{b}ⁿ⁻¹ and Rₑⁿ⁻¹ to obtain the transform coefficients F_{R}_{_{b}}_{^{n−1}}=f(R_{b}ⁿ⁻¹), F_{R}_{ₑ}_{^{n−1}}=f(Rₑⁿ⁻¹) respectively. A coefficient block F_{R}_{ₐ}_{ⁿ}(u,v), 0≦u<M, 0≦v<N is formed with each coefficient being a weighted average of coefficients from the base layer reference frame and that from the enhancement layer reference frame. The weighting factor depends on the base layer coefficient value.
   F_{R}_{ₐ}_{ⁿ}(u, v)=β·F_{R}_{_{b}}_{^{n−1}}(u, v)+(1−β)·F_{R}_{ₑ}_{^{n−1}}(u, v) if Q_{b}ⁿ(u, v)=0 (10)
   F_{R}_{ₐ}_{ⁿ}(u, v)=γ·F_{R}_{_{b}}_{^{n−1}}(u, v)+γₚ·F_{P}_{_{b}}_{ⁿ}(u, v)+(1−γ)·F_{R}_{ₑ}_{^{n−1}}(u, v) if Q_{b}ⁿ⁽u, v)≠0 (11)
The actual reference block is then obtained by performing inverse transform on
   F_{R}_{ₐ}_{ⁿ}: Rₐⁿ=g(F_{R}_{ₐ}_{ⁿ}).
   Equations 9, 10 and 11 can be reorganized as follows:
   Rₐⁿ=R_{b}ⁿ⁻¹+(1−α)·R_{d}ⁿ⁻¹ if Q_{b}ⁿ=0 (12)
   F_{R}_{ₐ}_{ⁿ}(u, v)=F_{R}_{_{b}}_{_{N−1}}(u, v)+(1−β)·_{R}_{_{d}}_{^{n−1}}(u, v) if Q_{b}ⁿ(u, v)=0 (13)
   F_{R}_{ₐ}_{ⁿ}(u, v)=F_{R}_{_{b}}_{^{n−1}}(u, v)+γₚ·F_{P}_{_{b}}_{ⁿ}(u, v)+(1−γ)·F_{R}_{_{d}}_{^{n−1}}(u, v) if Q_{b}ⁿ(u, v)≠0 (14)
   In Equations 12, 13 and 14, R_{d}ⁿ⁻¹ is the differential reference block, R_{d}ⁿ⁻¹=Rₑⁿ⁻¹−R_{b}ⁿ⁻¹.

Since the transform is linear, the differences between the transform coefficients can be calculated by performing the transform on the differential reference block.
F_{R}_{_{d}}_{^{n−1}}=F_{R}_{ₑ}_{^{n−1}}−F_{R}_{_{b}}_{^{n−1}}=f(Rₑⁿ⁻¹)−f(R_{b}ⁿ⁻¹)=f(Rₑⁿ⁻¹−R_{b}ⁿ⁻¹)=f(R_{d}ⁿ⁻¹) (15)
Three equations can be combined into a unified equation.
Rₐⁿ=R_{b}ⁿ⁻¹+R_{d}ⁿ⁻¹′+γ_{p·}P_{b}ⁿ (16)
The function R_{d}ⁿ⁻¹′ is defined as:
If all coefficients in the base layer block are zero, the differential reference block is scaled by one scaling factor (1−α):
   R_{d}ⁿ⁻¹′=(1−α)·R_{d}ⁿ⁻¹ if Q_{b}ⁿ=0 (17)
Otherwise, transform is performed on R_{d}ⁿ⁻¹ to obtain the transform coefficients F_{R}_{_{d}}_{^{n−1}}=f(R_{d}ⁿ⁻¹). Each coefficient is scaled based on whether the base layer coefficient is zero or not.
   F_{R}_{_{d}}_{^{n−1}}′(u, v)=(1−β)·F_{R}_{_{d}}_{^{n−1}}(u, v) if Q_{b}ⁿ(u, v)=0 (18)
   F_{R}_{_{d}}_{^{n−1}}′(u, v)=(1−γ)·F_{R}_{^{n−1}}(u, v) if Q_{d}ⁿ(u, v)≠0 (19)
Inverse transform on F_{R}_{_{d}}_{^{n−1}}′ is performed to obtain R_{d}ⁿ⁻¹′=g(F_{R}_{_{d}}_{^{n−1}}′).

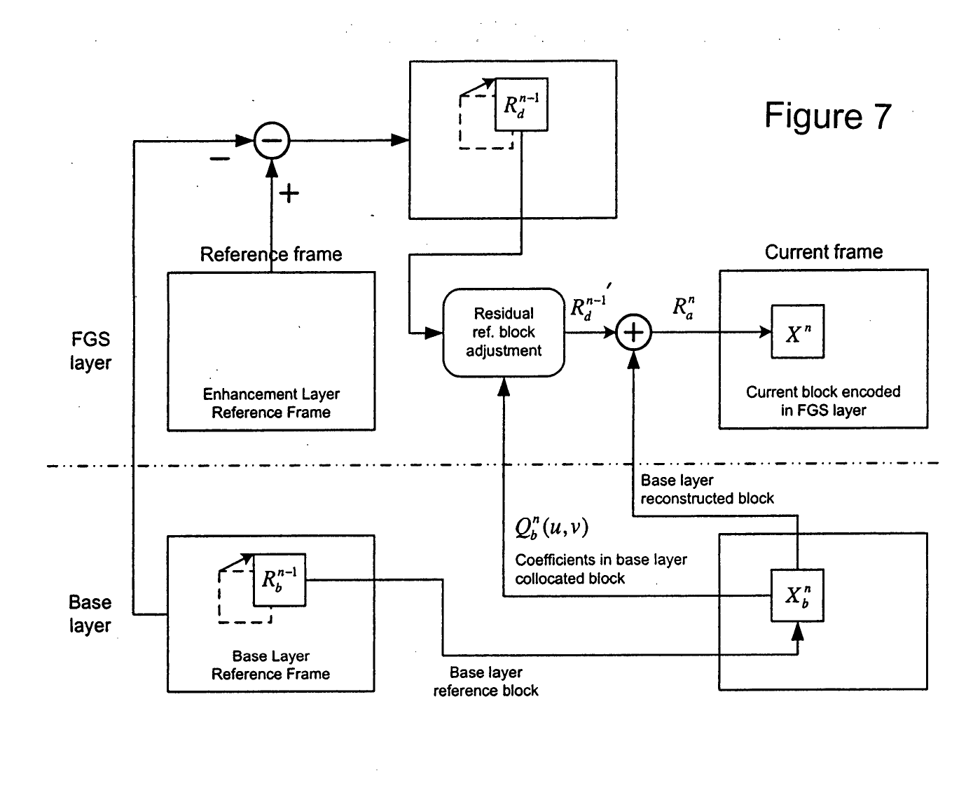

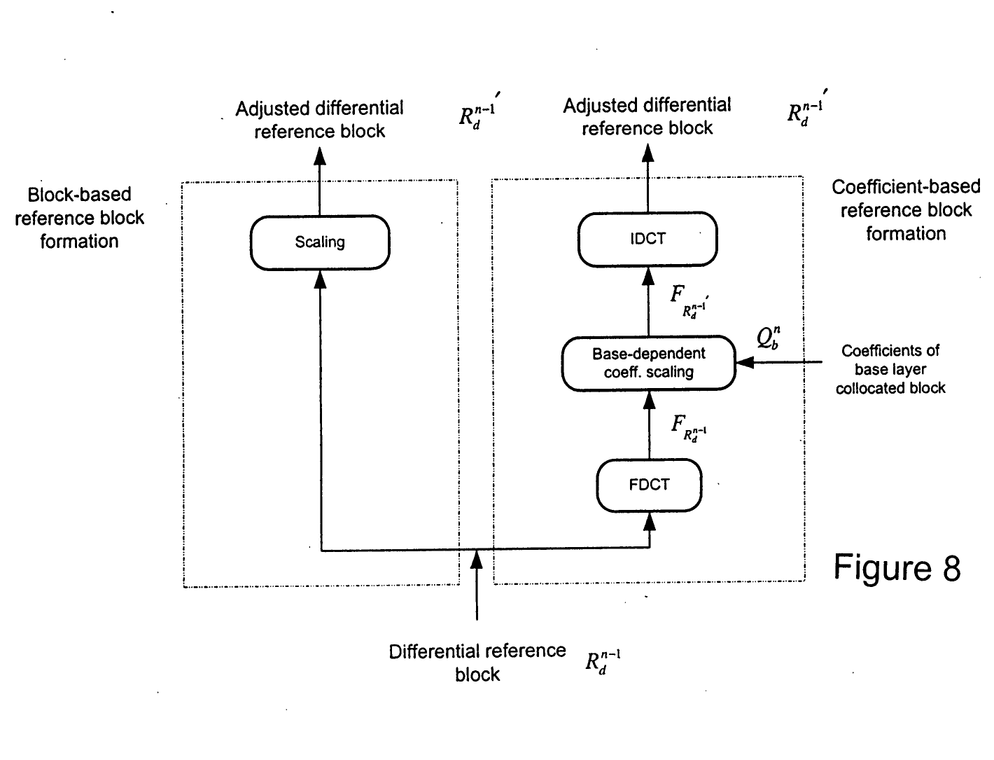

With this approach, R_{d}ⁿ⁻¹ can be generated by performing the motion compensation on the differential reference frame which is calculated by subtracting the base layer reference frame from the enhancement layer reference frame. Reference block formation by performing interpolation on differential reference frame is shown in FIG. 7, and the base-layer dependence differential reference block adjustment is illustrated in FIG. 8. One example of the interpolation filter is the filter for bilinear interpolation. By using the differential reference frame, in addition to the reduction in the complexity of the interpolation, there is only one forward transform needed.

In the description above, if the base layer reconstructed prediction residual is 0, the base layer reconstruction (x_{b}ⁿ) is the same as the base layer reference signal (r_{b}ⁿ⁻¹). For some implementations, the application may choose the following equations instead of Equations 12, 13 and 14 to simplify the implementation.
Rₐⁿ=X_{b}ⁿ+(1−α)·R_{d}ⁿ⁻¹ if Q_{b}ⁿ=0 (20)
F_{R}_{ₐ}_{ⁿ}(u, v)=F_{X}_{_{b}}_{ⁿ}(u, v)+(1−β)·F_{R}_{_{d}}_{^{n−1}}(u, v) if Q_{b}ⁿ(u, v)=0 (21)
F_{R}_{ₐ}_{ⁿ}(u, v)=F_{X}_{_{b}}_{ⁿ}(u, v)+(γₚ−1)·F_{P}_{_{b}}_{ⁿ}(u, v)+(1−γ)·F_{R}_{_{d}}_{^{n−1}}(u, v) if Q_{b}ⁿ(u, v)≠0 (22)
Equations 20, 21 and 22 can be used even if additional operations, such as loop filtering, are performed on the base layer reconstruction, although X_{b}ⁿ is now not always equal to R_{b}ⁿ⁻¹+P_{b}ⁿ because of the additional operations on “R_{b}ⁿ⁻¹+P_{b}^{n-”.}

According to the present invention, further classification is performed on the blocks whose base layer coefficients are all zero, and different weighting factors may be used for the blocks in different categories.

One classification technique is to classify a block depending on whether it has any neighboring blocks that have non-zero base layer coefficients. One way of performing such a classification is to use the coding context index for coding the coded block flag in the base layer as defined in H.264. In H.264, the coding context index is 0 if the coded block flags of both the left neighboring block and the top neighboring block are zero. The coding context index is 1 if only coded block flag of the left neighboring block is nonzero. The coding context index is 2 if only coded block flag of the top neighboring block is nonzero. Otherwise, the coding text index is 3.

Another classification technique is to use explicit signaling to indicate whether the reference block is only from the base layer reconstructed frame or from the weighted average between the base layer reconstructed frame and the enhancement reference frame in a way as described in this invention, or from the enhancement layer. The signaling can be performed at Macroblock (MB) level, and only for those MBs that do not have any nonzero coefficients in the base layer.

The transform operations are needed because different weighting factors are used for different coefficients within a block if the block in the base layer has any nonzero coefficients. If the same weighting factor is used for all the coefficients within a block, the transform operations are not necessary.

According to the present invention, the number of nonzero coefficients is counted in the base layer block. If the number of nonzero coefficients is larger than or equal to a pre-determined number Tc, all the coefficients in this block use a single weighting factor. The value of weighting factor may depend on the number of nonzero coefficients in the base layer. This threshold number Tc determines whether the entire block should use the same weighting factor. Tc is in the range between 1 and BlockSize. For example, for a 4×4 block, there are 16 coefficients in a block, and Tc is in the range between 1 and 16.

One special case is Tc=1, i.e., all the coefficients in a block always use the same weighting factor. In this case, no additional transform is needed. However, the value of weighting factor may depend on the number of nonzero coefficients in a block in the base layer.

Weighting Factors

The weighting factors can change from frame to frame or slice to slice, or they can be fixed for certain amount of frames or slices. The weighting factor β may depend on the number of nonzero coefficients in the base layer.

Here is an example of the relationship between the weighting factors, β and γ, and the number of nonzero coefficients in the base layer. In this example, γ is a constant for the slice. β is equal to β₁, β₁≦γ, when there is only one nonzero coefficient in the base layer. When the number of nonzero coefficients in the base layer is n and n is smaller than Tc, β is calculated using the equation, β=β₁+(γ−β₁)·(n−1)/(T_{c}−1). If n is equal to or lager than Tc, β is equal to γ.

Coding of Multiple FGS Layers

In the case when there are a discrete base layer and multiple FGS layers on top of the discrete base layer, the user may choose to use the discrete base layer as the “base layer” and the top-most FGS layer as the “enhancement layer” to implement the algorithms mentioned above. This is referred to as a two-loop structure.

The user may also use a multi-loop coding structure as follows:
The first coding loop is the normal discrete base layer coding loop.
The second coding loop is for coding the first FGS layer using the algorithms described in this disclosure. The “base layer” is the discrete base layer and the “enhancement layer”is the first FGS layer”.
In the third coding loop, the “base layer” is the first FGS layer and the “enhancement layer” is the second FGS layer, and so on.

Once the “base layer” is an FGS layer, the “base layer” coefficients considered are those in this FGS layer as well as other layers below this layer. Q_{b}ⁿ(u, v) is considered nonzero if the coefficient at the same position in any of these layers is nonzero. To apply the algorithms in an FGS coder using other coding structures is rather straightforward.

In the multi-loop structure, there are different ways of calculating the actual reference signal that is used in coding the second FGS layer or higher FGS layers. Since it is necessary to differentiate FGS layers, equation (16) needs to be changed slightly. Base layer still uses the subscript “b”, but the first FGS enhancement layer, which is the layer immediately on top of the base layer, uses the subscript “e₁”, and the second FGS enhancement layer uses the subscript “e₂” and so on. R_{d}ⁿ⁻¹′ is the adjusted differential reference signal calculated for coding the first FGS enhancement layer. Equation (23) is equivalent to equation (16) except for the changes of subscripts.
Rₐⁿ=R_{b}ⁿ⁻¹+R_{d}ⁿ⁻¹′+γ_{pb}·P_{b}ⁿ=Rₑ_{₁}ⁿ⁻¹′+γ_{pb}·P_{b}ⁿ (23)

For the second FGS enhancement layer, the actual reference signal can be calculated as in equation (24). R_{d}_{₂}ⁿ⁻¹′ is calculated from the differential reference frame which is the difference between the reference frame of the second FGS enhancement layer and the reference frame of the first enhancement layer. It can be seen that except there is one more reconstructed residual term, the equation is not much different from (23).
Rₐ_{₂}ⁿ=Rₑ_{₁}ⁿ⁻¹+R_{d}_{₂}ⁿ⁻¹′+γ_{pb}·P_{b}ⁿ+γₚ_{ₑ₁}·Pₑ_{₁}ⁿ (24)

There are three different methods to calculate Rₑ_{₁}ⁿ⁻¹. The first method is to perform motion compensation on the reference frame of the first FGS enhancement layer. In this invention, one of two other methods (method A and method B) for calculating the Rₑ_{₁}ⁿ⁻¹ can be used. For method A, Rₑ_{₁}ⁿ⁻¹ is set to be equal to R_{b}ⁿ⁻¹+R_{d}_{₁}ⁿ⁻¹. For method B, Rₑ_{₁}ⁿ⁻¹ is set to be equal to R_{b}ⁿ⁻¹+R_{d}_{₁}ⁿ⁻¹′.

In the present invention, the choice of the two-loop or multi-loop FGS coding can be an encoder choice and signaled in the bitstream. When the bitstream is changed from two-loop FGS coding to multi-loop coding for a frame, this frame has access to 2 reference frames, the base layer reference frame and the highest enhancement reference frame. However, all layers of this frame will be filly reconstructed so the next frame has all the reference frames needed for multi-loop FGS coding. If the bitstream is changed from multi-loop to two-loop, the current frame will be coded in multi-loop, but only the base layer and the highest FGS layer are fully reconstructed, since frames of any intermediate layers are no longer needed for the next frame.

With the present invention, the new predictors are calculated using motion compensation for coding the FGS layers. This requires the reconstruction of the enhancement layer reference frame needed. However, if the decoder wants to decode the layers above these FGS layers, the full reconstruction of the FGS layers can be avoided under certain constraints. For example, assume that there is a discrete base layer (L0), 2 FGS layers (F1, F2) on top of L0, and there is a discrete enhancement layer (L3) on top of FGS layer F2. If the layer L3 does not use the fully reconstructed Macroblock that is coded as inter-MB in the base layer L0 as predictors, instead it uses only the reconstructed residual in the prediction, when the decoder wants to reconstruct layer L3, it is only necessary to decode the residual information of layer F1 and F2 and no motion compensation is needed.

Overview of the FGS Coder

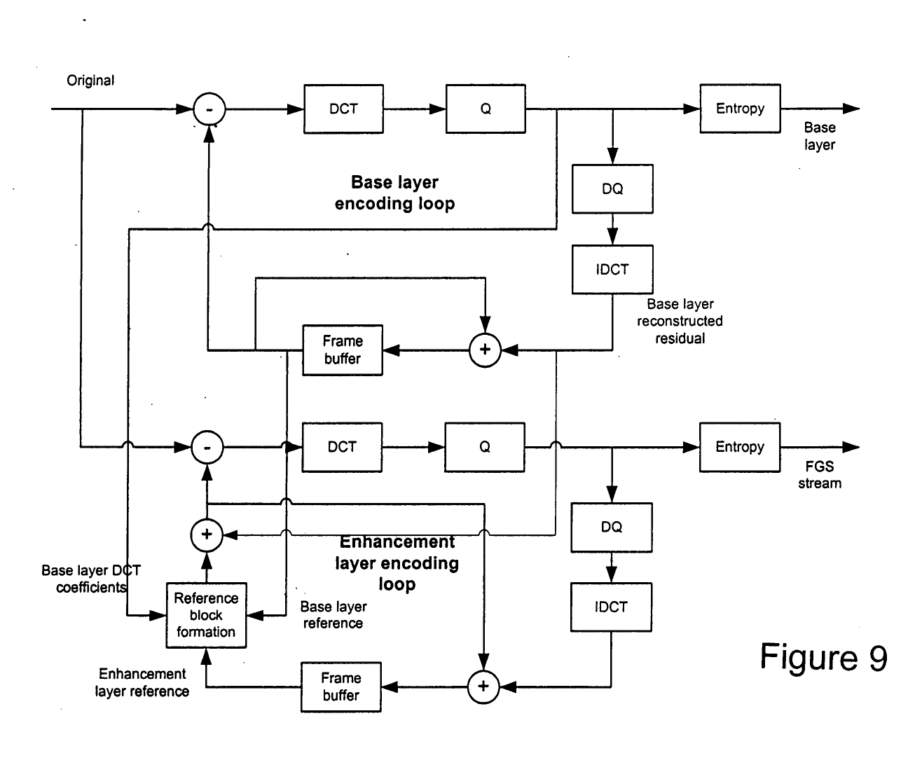

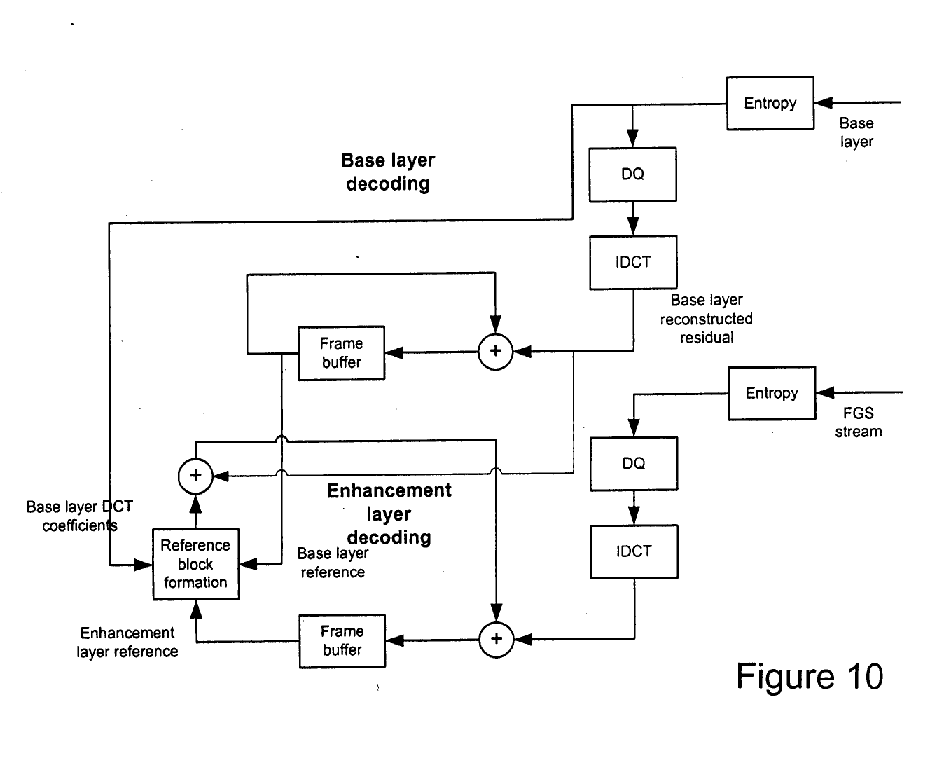

FIGS. 9 and 10 are block diagrams of the FGS encoder and decoder of the present invention wherein the formation of reference blocks is dependent upon the base layer. In these block diagrams, only one FGS layer is shown. However, it should be appreciated that the extension of one FGS layer to a structure having multiple FGS layers is straightforward.

As can be seen from the block diagrams, the FGS coder is a 2-loop video coder with additional “reference block formation module”.

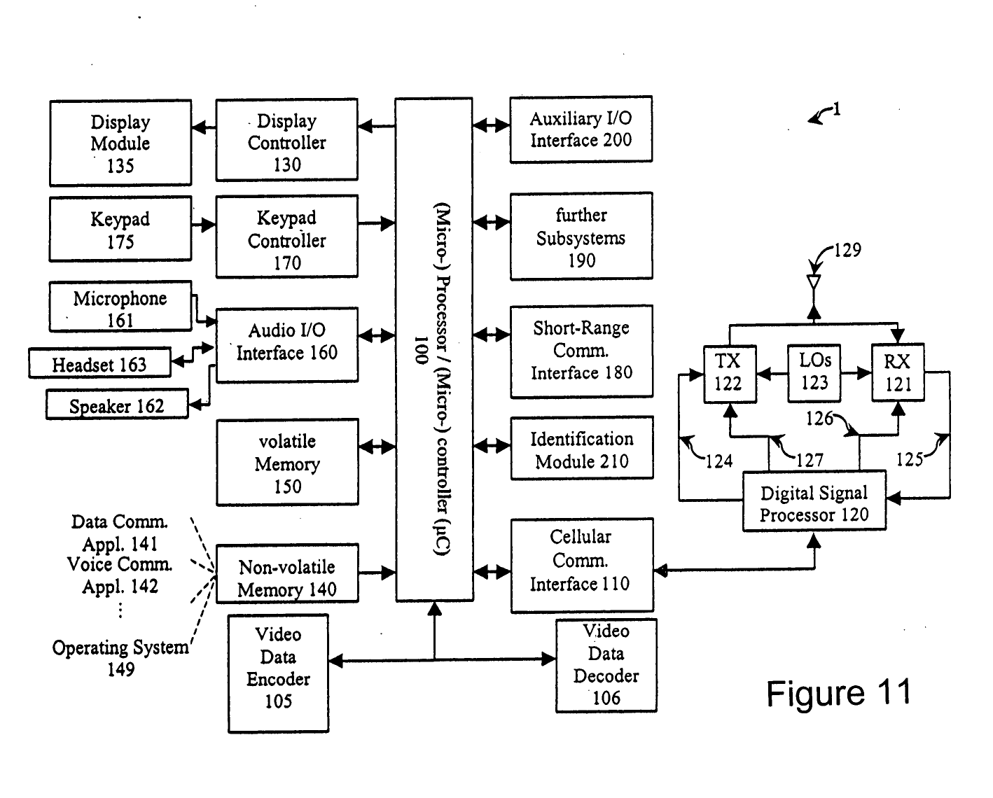

FIG. 11 depicts a typical mobile device according to an embodiment of the present invention. The mobile device 1 shown in FIG. 11 is capable of cellular data and voice communications. It should be noted that the present invention is not limited to this specific embodiment, which represents one of a multiplicity of different embodiments. The mobile device 1 includes a (main) microprocessor or microcontroller 100 as well as components associated with the microprocessor controlling the operation of the mobile device. These components include a display controller 130 connecting to a display module 135, a non-volatile memory 140, a volatile memory 150 such as a random access memory (RAM), an audio input/output (I/O) interface 160 connecting to a microphone 161, a speaker 162 and/or a headset 163, a keypad controller 170 connected to a keypad 175 or keyboard, any auxiliary input/output (I/O) interface 200, and a short-range communications interface 180. Such a device also typically includes other device subsystems shown generally at 190.

The mobile device 1 may communicate over a voice network and/or may likewise communicate over a data network, such as any public land mobile networks (PLMNs) in form of e.g. digital cellular networks, especially GSM (global system for mobile communication) or UMTS (universal mobile telecommunications system). Typically the voice and/or data communication is operated via an air interface, i.e. a cellular communication interface subsystem in cooperation with further components (see above) to a base station (BS) or node B (not shown) being part of a radio access network (RAN) of the infrastructure of the cellular network.

The cellular communication interface subsystem as depicted illustratively in FIG. 11 comprises the cellular interface 110, a digital signal processor (DSP) 120, a receiver (RX) 121, a transmitter (TX) 122, and one or more local oscillators (LOs) 123 and enables the communication with one or more public land mobile networks (PLMNs). The digital signal processor (DSP) 120 sends communication signals 124 to the transmitter (TX) 122 and receives communication signals 125 from the receiver (RX) 121. In addition to processing communication signals, the digital signal processor 120 also provides for the receiver control signals 126 and transmitter control signal 127. For example, besides the modulation and demodulation of the signals to be transmitted and signals received, respectively, the gain levels applied to communication signals in the receiver (RX) 121 and transmitter (TX) 122 may be adaptively controlled through automatic gain control algorithms implemented in the digital signal processor (DSP) 120. Other transceiver control algorithms could also be implemented in the digital signal processor (DSP) 120 in order to provide more sophisticated control of the transceiver 121/122.

In case the mobile device 1 communications through the PLMN occur at a single frequency or a closely-spaced set of frequencies, then a single local oscillator (LO) 123 may be used in conjunction with the transmitter (TX) 122 and receiver (RX) 121. Alternatively, if different frequencies are utilized for voice/data communications or transmission versus reception, then a plurality of local oscillators can be used to generate a plurality of corresponding frequencies.

Although the mobile device 1 depicted in FIG. 11 is used with the antenna 129 as or with a diversity antenna system (not shown), the mobile device 1 could be used with a single antenna structure for signal reception as well as transmission. Information, which includes both voice and data information, is communicated to and from the cellular interface 110 via a data link between the digital signal processor (DSP) 120. The detailed design of the cellular interface 110, such as frequency band, component selection, power level, etc., will be dependent upon the wireless network in which the mobile device 1 is intended to operate.

After any required network registration or activation procedures, which may involve the subscriber identification module (SIM) 210 required for registration in cellular networks, have been completed, the mobile device 1 may then send and receive communication signals, including both voice and data signals, over the wireless network. Signals received by the antenna 129 from the wireless network are routed to the receiver 121, which provides for such operations as signal amplification, frequency down conversion, filtering, channel selection, and analog to digital conversion. Analog to digital conversion of a received signal allows more complex communication functions, such as digital demodulation and decoding, to be performed using the digital signal processor (DSP) 120. In a similar manner, signals to be transmitted to the network are processed, including modulation and encoding, for example, by the digital signal processor (DSP) 120 and are then provided to the transmitter 122 for digital to analog conversion, frequency up conversion, filtering, amplification, and transmission to the wireless network via the antenna 129.

The microprocessor/microcontroller (μC) 110, which may also be designated as a device platform microprocessor, manages the functions of the mobile device 1. Operating system software 149 used by the processor 110 is preferably stored in a persistent store such as the non-volatile memory 140, which may be implemented, for example, as a Flash memory, battery backed-up RAM, any other non-volatile storage technology, or any combination thereof. In addition to the operating system 149, which controls low-level functions as well as (graphical) basic user interface functions of the mobile device 10, the non-volatile memory 140 includes a plurality of high-level software application programs or modules, such as a voice communication software application 142, a data communication software application 141, an organizer module (not shown), or any other type of software module (not shown). These modules are executed by the processor 100 and provide a high-level interface between a user of the mobile device 1 and the mobile device 1. This interface typically includes a graphical component provided through the display 135 controlled by a display controller 130 and input/output components provided through a keypad 175 connected via a keypad controller 170 to the processor 100, an auxiliary input/output (I/O) interface 200, and/or a short-range (SR) communication interface 180. The auxiliary I/O interface 200 comprises especially USB (universal serial bus) interface, serial interface, MMC (multimedia card) interface and related interface technologies/standards, and any other standardized or proprietary data communication bus technology, whereas the short-range communication interface radio frequency (RF) low-power interface includes especially WLAN (wireless local area network) and Bluetooth communication technology or an IRDA (infrared data access) interface. The RF low-power interface technology referred to herein should especially be understood to include any IEEE 801.xx standard technology, which description is obtainable from the Institute of Electrical and Electronics Engineers. Moreover, the auxiliary I/O interface 200 as well as the short-range communication interface 180 may each represent one or more interfaces supporting one or more input/output interface technologies and communication interface technologies, respectively. The operating system, specific device software applications or modules, or parts thereof, may be temporarily loaded into a volatile store 150 such as a random access memory (typically implemented on the basis of DRAM (direct random access memory) technology for faster operation). Moreover, received communication signals may also be temporarily stored to volatile memory 150, before permanently writing them to a file system located in the non-volatile memory 140 or any mass storage preferably detachably connected via the auxiliary I/O interface for storing data. It should be understood that the components described above represent typical components of a traditional mobile device 1 embodied herein in the form of a cellular phone. The present invention is not limited to these specific components and their implementation depicted merely for illustration and for the sake of completeness.

An exemplary software application module of the mobile device 1 is a personal information manager application providing PDA functionality including typically a contact manager, calendar, a task manager, and the like. Such a personal information manager is executed by the processor 100, may have access to the components of the mobile device 1, and may interact with other software application modules. For instance, interaction with the voice communication software application allows for managing phone calls, voice mails, etc., and interaction with the data communication software application enables for managing SMS (soft message service), MMS (multimedia service), e-mail communications and other data transmissions. The non-volatile memory 140 preferably provides a file system to facilitate permanent storage of data items on the device including particularly calendar entries, contacts etc. The ability for data communication with networks, e.g. via the cellular interface, the short-range communication interface, or the auxiliary I/O interface enables upload, download, and synchronization via such networks.

The application modules 141 to 149 represent device functions or software applications that are configured to be executed by the processor 100. In most known mobile devices, a single processor manages and controls the overall operation of the mobile device as well as all device functions and software applications. Such a concept is applicable for today's mobile devices. The implementation of enhanced multimedia functionalities includes, for example, reproducing of video streaming applications, manipulating of digital images, and capturing of video sequences by integrated or detachably connected digital camera functionality. The implementation may also include gaming applications with sophisticated graphics and the necessary computational power. One way to deal with the requirement for computational power, which has been pursued in the past, solves the problem for increasing computational power by implementing powerful and universal processor cores. Another approach for providing computational power is to implement two or more independent processor cores, which is a well known methodology in the art. The advantages of several independent processor cores can be immediately appreciated by those skilled in the art. Whereas a universal processor is designed for carrying out a multiplicity of different tasks without specialization to a pre-selection of distinct tasks, a multi-processor arrangement may include one or more universal processors and one or more specialized processors adapted for processing a predefined set of tasks. Nevertheless, the implementation of several processors within one device, especially a mobile device such as mobile device 1, requires traditionally a complete and sophisticated re-design of the components.

In the following, the present invention will provide a concept which allows simple integration of additional processor cores into an existing processing device implementation enabling the omission of expensive complete and sophisticated redesign. The inventive concept will be described with reference to system-on-a-chip (SoC) design. System-on-a-chip (SoC) is a concept of integrating at least numerous (or all) components of a processing device into a single high-integrated chip. Such a system-on-a-chip can contain digital, analog, mixed-signal, and often radio-frequency functions—all on one chip. A typical processing device comprises a number of integrated circuits that perform different tasks. These integrated circuits may include especially microprocessor, memory, universal asynchronous receiver-transmitters (UARTs), serial/parallel ports, direct memory access (DMA) controllers, and the like. A universal asynchronous receiver-transmitter (UART) translates between parallel bits of data and serial bits. The recent improvements in semiconductor technology cause very-large-scale integration (VLSI) integrated circuits to enable a significant growth in complexity, making it possible to integrate numerous components of a system in a single chip. With reference to FIG. 11, one or more components thereof, e.g. the controllers 130 and 170, the memory components 150 and 140, and one or more of the interfaces 200, 180 and 110, can be integrated together with the processor 100 in a signal chip which forms finally a system-on-a-chip (Soc).

Additionally, the device 1 is equipped with a module for scalable encoding 105 and scalable decoding 106 of video data according to the inventive operation of the present invention. By means of the CPU 100 said modules 105, 106 may individually be used. However, the device 1 is adapted to perform video data encoding or decoding respectively. Said video data may be received by means of the communication modules of the device or it also may be stored within any imaginable storage means within the device 1.

Although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method for motion compensated scalable video coding, comprising:
forming a reference block based on a base layer reference block and an enhancement layer reference block together with a base layer reconstructed prediction residual block, wherein the reference block is for coding a block in a current frame in a fine-grain scalable layer, and the base layer reference block is used as reference for reconstruction of the frame in the base layer and the enhancement layer reference block is formed from reference frames in the fine-grain scalable layer; and
adjusting the reference block at least based on transform coefficients of the base layer reconstructed prediction residual block.

2. The method of claim 1, wherein when the transform coefficients of base layer reconstructed prediction residual block are all zero, said adjusting comprises:
choosing a weighting factor so that the reference block is formed as a weighted average of the base layer reference block and the enhancement layer reference block.

3. The method of claim 1, wherein when the transform coefficients of base layer reconstructed prediction residual block include one or more non-zero coefficients, said forming comprises:
transforming the base layer reference block into base layer transform coefficients;
transforming the enhancement layer reference block into enhancement layer transform coefficients;
calculating transform coefficients for the reference block based on the base layer transform coefficients and the enhancement layer transform coefficients; and
converting the reference block transform coefficients for obtaining the reference block.

4. The method of claim 3, wherein said calculating comprises:
choosing, for each reference block transform coefficient, a first weighting factor and a second weighting factor, such that:
if a collocated transform coefficient of the base layer reconstructed prediction residual block is zero, the reference block transform coefficient is formed as a weighted average of the collocated base layer transform coefficient and the collocated enhancement layer transform coefficient based at least on the first weighting factor; and
if the collocated transform coefficient of the base layer reconstructed prediction residual block is non-zero, the reference block transform coefficient is formed as a weighted average of the collocated base layer transform coefficient and the collocated enhancement layer transform coefficient based at least on the second weighting factor.

5. The method of claim 4, wherein at least one of the first and second weighting factors is determined individually for each of the transform coefficients based on the frequency of the coefficient, wherein the frequency is represented by the location in the transformed block.

6. The method of claim 4, wherein at least one of the first and second weighting factor is determined based on a fine-grain scalable coding cycle in which the current coefficient is coded.

7. The method of claim 2, wherein the weighting factor is determined based at least on whether the block has one or more neighboring blocks with non-zero transform coefficients of the base layer reconstructed prediction residual block.

8. The method of claim 7, wherein the weighting factor is determined based at least on a coding context index for coding a coded block flag of the base layer reconstructed prediction residual block.

9. The method of claim 2, wherein the reference block is formed for blocks within a macroblock according to one of three manners:
a) formed only from the base layer reference block;
b) formed only from the enhancement layer reference block; and
c) formed as a weighted average of the base layer reference block and the enhancement layer reference block, wherein a flag is used at a macroblock level to signal the manner in which the reference block is formed for blocks within a macroblock.

10. The method of claim 4, further comprising:
comparing the number of non-zero transform coefficients of the base layer reconstructed prediction residual block to a predetermined value, and
setting the first weighting factor equal to the second weighting factor if said number is larger than or equal to the predetermined value.

11. The method of claim 10, wherein when the first and second weighting factors are set to be equal, their value is calculated based on the number of non-zero transform coefficients in the base layer reconstructed prediction residual block.

12. The method of claim 1, wherein a sum of the formed reference block and a scaled version of the base layer reconstructed prediction residual block is used as a reference signal for coding.

13. The method of claim 12, wherein the scaling factor of 1 is used to calculate the scaled version of the base layer reconstructed prediction residual block.

14. The method of claim 1, wherein the fine-grain scalable layer comprises multiple fine-grain scalable layers including a top-most layer, and wherein a discrete base layer is used for obtaining the base layer reference block, and the top-most layer is used for obtaining the enhancement layer reference block.

15. The method of claim 1, wherein the fine-grain scalable layer comprises multiple fine-grain scalable layers including a top-most layer, and wherein a current layer is used for obtaining the enhancement layer reference block, and a layer immediately below the current layer is used for obtaining the base layer reference block.

16. The method of claim 1, wherein said adjusting comprises:
calculating a differential reference block as the difference between enhancement layer reference block and the base layer reference block;
adjusting the differential reference block at least based on transform coefficients of the base layer reconstructed prediction residual block; and
obtaining the reference block as the sum of the adjusted differential reference block and the base layer reference block.

17. The method of claim 16, wherein when the transform coefficients of base layer reconstructed prediction residual block are all zero, said adjusting for differential reference block comprises:
choosing a weighting factor applied to the differential reference block so that the reference block is formed as a weighted average of the base layer reference block and the enhancement layer reference block.

18. The method of claim 16, wherein when the transform coefficients of base layer reconstructed prediction residual block include one or more non-zero coefficients, said adjusting for differential reference block comprises:
transforming differential reference block into transform coefficients;
adjusting transform coefficients; and
converting the transform coefficients for obtaining adjusted differential reference block.

19. An electronic module for use in motion compensated scalable video coding, comprising:
a formation module for forming a reference block based on a base layer reference block, an enhancement layer reference block and a base layer reconstructed prediction residual block, wherein the reference block is for coding a block in a current frame in a fine-grain scalable layer, and the base layer reference block is used as reference for reconstruction of the frame in the base layer and the enhancement layer reference block is formed from reference frames in the fine-grain scalable layer; and
an adjustment module for adjusting the reference block at least based on transform coefficients of the base layer reconstructed prediction residual block.

20. The electronic module of claim 19, wherein when the transform coefficients of base layer reconstructed prediction residual block include one or more non-zero coefficients, said formation module comprises:
a transform module for transforming the base layer reference block into base layer transform coefficients and transforming the enhancement layer reference block into enhancement layer transform coefficients;
a calculation module for calculating transform coefficients for the reference block based on the base layer transform coefficients and the enhancement layer transform coefficients; and
an inverse transform module for converting the reference block transform coefficients for obtaining the reference block.

21. The electronic module of claim 19, wherein a sum of the formed reference block and a scaled version of the base layer reconstructed prediction residual block is used as a reference signal for coding.

22. The electronic module of claim 19, wherein the fine-grain scalable layer comprises multiple fine-grain scalable layers including a top-most layer, and wherein a discrete base layer is used for obtaining the base layer reference block, and the top-most layer is used for obtaining the enhancement layer reference block.

23. The electronic module of claim 19, wherein the fine-grain scalable layer comprises multiple fine-grain scalable layers including a top-most layer, and wherein a current layer is used for obtaining the enhancement layer reference block, and a layer immediately below the current layer is used for obtaining the base layer reference block.

24. The electronic module of claim 19, wherein the adjustment module is adapted for:
calculating a differential reference block as the difference between enhancement layer reference block and the base layer reference block;
adjusting the differential reference block at least based on transform coefficients of the base layer reconstructed prediction residual block; and
obtaining the reference block as the sum of the adjusted differential reference block and the base layer reference block.

25. The electronic module of claim 19, comprising a decoder.

26. A software application product comprising a storage medium having a software application for use in motion compensated scalable video coding, said software application comprising:
program code for forming a reference block based on a base layer reference block, an enhancement layer reference block and a base layer reconstructed prediction residual block, wherein the reference block is for use in coding a block in a current frame in a fine-grain scalable layer, and the base layer reference block is used as reference for reconstruction of the frame in the base layer and the enhancement layer reference block is formed from reference frames in the fine-grain scalable layer; and
program code for adjusting the reference block at least based on transform coefficients of the base layer reconstructed prediction residual block.

27. The software application product of claim 26, wherein said software application is further comprising:
program code for choosing a weighting factor so that the reference block is formed as a weighted average of the base layer reference block and the enhancement layer reference block, when the transform coefficients of base layer reconstructed prediction residual block are all zero.

28. The software application product of claim 26, wherein the program code for forming the reference block comprises:
code for transforming the base layer reference block into base layer transform coefficients and transforming the enhancement layer reference block into enhancement layer transform coefficients;
code for calculating transform coefficients for the reference block based on the base layer transform coefficients and the enhancement layer transform coefficients; and
code converting the reference block transform coefficients for obtaining the reference block when the transform coefficients of the base layer reconstructed prediction residual block include one or more non-zero coefficients.

29. The software application product of claim 28, wherein, for each reference block transform coefficient, the reference block transform coefficient is formed as a weighted average of a collocated base layer transform coefficient and the collocated enhancement layer transform coefficient based on a first weighting factor if a collocated transform coefficient of the base layer reconstructed prediction residual block is zero, and based on a second weighting factor if the collocated transform coefficient of the base layer reconstructed prediction residual block is non-zero.

30. The software application product of claim 29, wherein the software application further comprises:
program code for comparing the number of non-zero transform coefficients of the base layer reconstructed prediction residual block to a predetermined value, so that the first weighting factor is set equal to the second weighting factor if said number is larger than or equal to the predetermined value, wherein the first and second weighting factors are calculated based on the number of non-zero transform coefficients of the base layer reconstructed prediction residual block.

31. The software application product of claim 26, wherein the fine-grain scalable layer comprises multiple fine-grain scalable layers including a top-most layer, and wherein a discrete base layer is used for obtaining the base layer reference block, and the top-most layer is used for obtaining the enhancement layer reference block.

32. The software application product of claim 26, wherein the fine-grain scalable layer comprises multiple fine-grain scalable layers including a top-most layer, and wherein a current layer is used for obtaining the enhancement layer reference block, and a layer immediately below the current layer is used for obtaining the base layer reference block.

33. The software program product of claim 26, wherein the program code for adjusting the reference block comprises code for:
calculating a differential reference block as the difference between enhancement layer reference block and the base layer reference block;
adjusting the differential reference block at least based on transform coefficients of the base layer reconstructed prediction residual block; and
obtaining the reference block as the sum of the adjusted differential reference block and the base layer reference block.

34. An electronic device adapted to receive video data, comprising:
a video data processing module for use in motion compensated scalable video coding of the video data, the processing module comprising:
a formation module for forming a reference block based on a base layer reference block, an enhancement layer reference block and a base layer reconstructed prediction residual block, wherein the reference block is for coding a block in a current frame in a fine-grain scalable layer, and the base layer reference block is used as reference for reconstruction of the frame in the base layer and the enhancement layer reference block is formed from reference frames in the fine-grain scalable layer; and
an adjustment module for adjusting the reference block at least based on transform coefficients of the base layer reconstructed prediction residual block.

35. The electronic device of claim 34, wherein when the transform coefficients of base layer reconstructed prediction residual block are all zero, said adjustment module is adapted to choose a weighting factor so that the reference block is formed as a weighted average of the base layer reference block and the enhancement layer reference block.

36. The electronic device of claim 34, wherein when the transform coefficients of base layer reconstructed prediction residual block include one or more non-zero coefficients, said formation module comprises:
a transform module for transforming the base layer reference block into base layer transform coefficients and transforming the enhancement layer reference block into enhancement layer transform coefficients;
a calculation module for calculating transform coefficients for the reference block based on the base layer transform coefficients and the enhancement layer transform coefficients; and
an inverse transform module for converting the reference block transform coefficients for obtaining the reference block.

37. The electronic device of claim 36, wherein said calculation module is adapted to choose, for each reference block transform coefficient, a first weighting factor and a second weighting factor, such that:
if a collocated transform coefficient of the base layer reconstructed prediction residual block is zero, the reference block transform coefficient is formed as a weighted average of the collocated base layer transform coefficient, and the collocated enhancement layer transform coefficient is based at least on the first weighting factor; and
if the collocated transform coefficient in the base layer reconstructed prediction residual block is non-zero, the reference block transform coefficient is formed as a weighted average of the collocated base layer transform coefficient, and the collocated enhancement layer transform coefficient based at least on the second weighting factor.

38. The electronic device of claim 37, wherein said calculation module is further adapted to compare the number of non-zero transform coefficients in the base layer reconstructed prediction residual block to a predetermined value, so that if said number is larger than or equal to the predetermined value, the first weighting factor is set equal to the second weighting factor.

39. The electronic device of claim 34, wherein the processing module comprises a video decoder module and wherein the formation module and the adjustment module are part of the video decoder module.

40. The electronic device of claim 34, wherein the processing module comprises a video encoder module and wherein the formation module and the adjustment module are part of the video encoder module.

41. The electronic device of claim 34, comprising a mobile terminal.

42. An electronic module for use in a video coding module for motion compensated scalable video coding, comprising:
means for forming a reference block based on a base layer reference block and an enhancement layer reference block together with a base layer reconstructed prediction residual block, wherein the reference block is for coding a block in a current frame in a fine-grain scalable layer, and the base layer reference block is used as reference for reconstruction of the frame in the base layer and the enhancement layer reference block is formed from reference frames in the fine-grain scalable layer; and
means for adjusting the reference block at least based on transform coefficients of the base layer reconstructed prediction residual block.
